(19) United States
(12) Patent Application Publication
(10) Pub. No.: US 2026/0356748 A1
(43) Pub. Date: Nov. 12, 2026

(54) Reflective Granular Compositions Containing Cristobalite

(71) Applicant: U.S. Silica Company, Katy, TX (US)

(72) Inventors: Ramanan Pitchumani, Hagerstown, MD (US); James Alan Brady, Berkeley Springs, WV (US); David Earl Weller, Jr., Greencastle, PA (US)

(21) Appl. No.: 19/119,816

(22) PCT Filed: Oct. 11, 2023
(86) PCT No.: PCT/US2023/034902

§ 371 Date: Apr. 10, 2025

Related U.S. Application Data
(60) Provisional application No. 63/415,119, filed on Oct. 11, 2022.

(51) Int. Cl. C04B 14/06; C04B 22/08; C04B 41/00; C04B 103/14; C04B 111/00; C04B 111/80

(52) U.S. Cl. CPC C04B 14/06; C04B 22/08; C04B 41/0072; C04B 2103/14; C04B 2111/00586; C04B 2111/80

(57) ABSTRACT

The present disclosure is directed to a reflective granular composition including: a reflective pigment material including cristobalite and at least 5 weight % of a hardening agent, based on the total solids weight of the composition. The present disclosure is also directed to an architectural material including the reflective granular composition. The present disclosure is also directed to a method of making the reflective granular composition.

### CROSS-REFERENCE TO RELATED APPLICATIONS

This application claims priority to U.S. Provisional Application No. 63/415,119, filed on Oct. 11, 2022. The entire disclosure is incorporated herein by reference.

### BACKGROUND

### Field

The present disclosure relates to reflective granular compositions containing cristobalite and methods for making the same.

### Technical Considerations

Commercial and residential roofs are continuously exposed to the outside elements, which are often harsh or extreme. Even under moderate external conditions, these roofs are exposed to environmental or weather conditions that affect the ability of the roofs to insulate the building or residence interiors from the effects of the environmental or weather conditions. In many parts of the world, during the summer months, roofs are continuously exposed to high heat and sunny conditions under which the roofing materials absorb solar energy and retain high levels of heat. As the roofs absorb the solar energy and retain heat, the conditions inside the underlying buildings or residences suffer adversely, which often causes the interiors to heat up to uncomfortable conditions.

In order to remedy these conditions, the buildings or residences often resort to increased amounts of internal insulation, or increased use of artificial cooling systems (e.g., HVAC equipment). However, increasing the amount of insulation has a limited ability to reduce heat transfer, and increasing energy costs make the increased use of artificial cooling systems undesirable or even cost-prohibitive.

Accordingly, it would be desirable to provide roofs more resistant to temperature increases induced by incident solar radiation.

### SUMMARY

The present disclosure relates to a reflective granular composition including: a reflective pigment material comprising cristobalite; and at least 5 weight % of a hardening agent, based on the total solids weight of the composition. The hardening agent can include, for example, a sodium salt.

In some non-limiting embodiments, the reflective pigment material consists of cristobalite. In such embodiments, the composition comprises at least 50 weight % cristobalite, based on the total solids weight of the composition. For example, the composition can comprise an amount of cristobalite selected within a range of from 50 weight % to 95 weight %, based on the total solids weight of the composition. The composition can also comprise an amount of hardening agent selected with a range of from 5 weight % to 40 weight %, based on the total solids weight of the composition.

In certain non-limiting embodiments, the cristobalite has a d90 selected within a range of from 1 μm to 40 μm. The reflective granules can also have a particle size selected within a range of from 8 mesh to 40 mesh.

In some non-limiting embodiments, the reflective pigment material further comprises a secondary pigment component selected from the group consisting of: kaolin clay, metal and transition metal oxides, alkaline earth metal sulfates, alkaline earth metal carbonates, transition metal silicates, minerals, and mixtures thereof. In some non-limiting embodiments, the composition exhibits a total solar reflectance of at least 70%.

The present disclosure also relates to an architectural material comprising the reflective granular composition previously described. In certain non-limiting embodiments, the architectural material comprises a roofing material.

The present disclosure further relates to a method of preparing a reflective granular composition comprising: mixing together quartz sand with water to form a slurry; adding and mixing a hardening agent into the slurry; granulating and/or drying the slurry; kilning a resulting material to form a sintered material comprising cristobalite and the hardening agent; and crushing and sieving the sintered material to form a reflective granular composition having a desired particle size.

In some non-limiting embodiments, the kilning is performed at a temperature of from 900 °C to 1500 °C. In certain non-limiting embodiments, the sintered material is crushed and sieved to form the reflective granular composition having a particle size selected within a range of from 8 mesh to 40 mesh. The hardening agent, reflective pigment material and other components previously described and further described herein can be used in the method to prepare the various compositions.

In certain non-limiting embodiments, the method of preparing a reflective granular composition comprises mixing together cristobalite, and a hardening agent to form a reflective granular composition. The method can further comprise crushing and sieving the reflective granular composition to have a desired particle size, such as a particle size selected within a range of from 8 mesh to 40 mesh. In some non-limiting embodiments, the hardening agent comprises a sodium salt.

The present disclosure also relates to the following clauses.

Clause 1: A reflective granular composition comprising: a reflective pigment material comprising cristobalite; and at least 5 weight % of a hardening agent, based on the total solids weight of the composition.

Clause 2: The reflective granular composition of clause 1, wherein the hardening agent comprises a sodium salt.

Clause 3: The reflective granular composition of clauses 1 or 2, wherein the reflective pigment material consists of cristobalite.

Clause 4: The reflective granular composition of clause 3, wherein the composition comprises at least 50 weight % cristobalite, based on the total solids weight of the composition.

Clause 5: The reflective granular composition of clause 4, wherein the composition comprises an amount of cristobalite selected within a range of from 50 weight % to 95 weight %, based on the total solids weight of the composition.

Clause 6: The reflective granular composition of any one of clauses 1-5, wherein the composition comprises an amount of hardening agent selected with a range of from 5 weight % to 40 weight %, based on the total solids weight of the composition.

Clause 7: The reflective granular composition of any one of clauses 1-6, wherein the cristobalite has a d90 selected with a range of from 1 μm to 40 μm.

Clause 8: The reflective granular composition of any one of clauses 1-7, wherein the reflective granules have a particle size selected within a range of from 8 mesh to 40 mesh.

Clause 9: The reflective granular composition of any one of clauses 1-2 and 6-8, wherein the reflective pigment material further comprises a secondary pigment component selected from the group consisting of: kaolin clay, metal and transition metal oxides, alkaline earth metal sulfates, alkaline earth metal carbonates, transition metal silicates, minerals, and mixtures thereof.

Clause 10: The reflective granular composition of any one of clauses 1-9, wherein the composition exhibits a total solar reflectance of at least 70%.

Clause 11: An architectural material comprising the reflective granular composition of any one of clauses 1-10.

Clause 12: The architectural material of clause 11, wherein the architectural material comprises a roofing material.

Clause 13: A method of preparing a reflective granular composition comprising: mixing together quartz sand with water to form a slurry; adding and mixing a hardening agent into the slurry; granulating and/or drying the slurry; kilning a resulting material to form a sintered material comprising cristobalite and the hardening agent; and crushing and sieving the sintered material to form a reflective granular composition having a desired particle size.

Clause 14: The method of clause 13, wherein the kilning is performed at a temperature of from 900 °C to 1500 °C.

Clause 15: The method of clauses 13 or 14, wherein the sintered material is crushed and sieved to form the reflective granular composition having a particle size selected within a range of from 8 mesh to 40 mesh.

Clause 16: The method of any one of clause 13-15, wherein the hardening agent comprises a sodium salt.

Clause 17: The method of any one of clause 13-16, wherein a reflective pigment material of the reflective granular composition consists of cristobalite.

Clause 18: The method of any one of clause 13-16, wherein the reflective pigment material further comprises a secondary pigment component selected from the group consisting of: kaolin clay, metal and transition metal oxides, alkaline earth metal sulfates, alkaline earth metal carbonates, transition metal silicates, minerals, and mixtures thereof.

Clause 19: A method of preparing a reflective granular composition comprising: mixing together cristobalite, and a hardening agent to form a reflective granular composition.

Clause 20: The method of clause 19, further comprising crushing and sieving the reflective granular composition to have a desired particle size.

Clause 21: The method of clause 20, wherein the reflective granular composition is crushed and sieved to a particle size selected within a range of from 8 mesh to 40 mesh.

### DETAILED DESCRIPTION

For purposes of the following detailed description, it is understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in its respective testing measurement.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise.

As used herein, the transitional term “comprising” (and other comparable terms, e.g., “containing” and “including”) is “open-ended” and open to the inclusion of unspecified matter. Although described in terms of “comprising”, the terms “consisting essentially of” and “consisting of” are also within the scope of the invention.

As used herein, the term “granular roofing material,” “particulate roofing material,” and like terms, refer to solar reflective particulates or granules that are useful in so-called “cool roof” applications, and these terms are used interchangeably with the terms “solar reflective particulates,” “solar reflective granules,” “reflective particulates,” “reflective granules,” and like terms. Additionally, while the particulates and granules described herein are described in terms of their efficacy in “cool roof” applications, it is understood that the described particulates and granules may have other uses and applications, and that the described embodiments are not limited to use in “cool roof” applications. For example, in some non-limiting embodiments, the particulate roofing materials described herein may be useful on any exterior surface, for example, as a filler in an exterior paint, or like application.

In certain non-limiting embodiments, a reflective granular composition comprises: a reflective pigment material comprising cristobalite; and a hardening agent. As used herein, “cristobalite” refers to a crystalline polymorph of silica. The cristobalite used to form the reflective pigment material can have a particulate structure with a doo particle size selected within a range of from 1 μm to 40 μm, or from 1 μm to 30 μm, or from 3 μm to 20 μm, or from 5 μm to 10 μm, such as 5 μm or 10 μm. As used herein, a “d90 particle size” refers to the average diameter of a sample of particles where 90 weight percent of the particles have sizes smaller than the deo value given. The doo particle sizes are determined by sieving with a stack of US Standard test sieves.

The cristobalite in the reflective granular composition may function as a reflective pigment which is highly reflective at certain wavelengths of solar radiation which reach the Earth's surface. When the reflective granular composition is arranged at a surface of an object positioned in outdoor conditions, the cristobalite may reflect at least a portion of the solar radiation incident to the object to reduce the rise in temperature of the object caused by the incident solar radiation (by the object absorbing less and reflecting more solar radiation compared to the same object coated with the same composition not containing the cristobalite).

In some non-limiting embodiments, the reflective pigment material may include at least one secondary pigment component. For example, the secondary pigment components may include additional pigment materials, and/or pigment additives. Some non-limiting examples of suitable secondary pigment components include metal and transition metal oxides (e.g., TiO₂, ZnO, SnO, and various titanates), alkaline earth metal sulfates (e.g., BaSO₄, MgSO₄ (including anhydrous or hydrated forms, such as, e.g., Epsom salt) and the like), alkaline earth metal carbonates (e.g., SrCO₃ and BaCO₃), transition metal silicates (e.g., ZrSiO₄), and minerals. For example, in some non-limiting embodiments, the secondary pigment component may include kaolin clay.

In some non-limiting embodiments, the composition comprises at least 50 weight % cristobalite, or at least 60 weight % cristobalite, or at least 70 weight % cristobalite, based on the total solids weight of the composition. The composition can also comprise up to 95 weight % cristobalite, or up to 90 weight % cristobalite, or up to 80 weight % cristobalite, based on the total solids weight of the composition. For example, the composition can comprise an amount of cristobalite selected within a range of from 50 weight % to 95 weight %, or from 60 weight % to 95 weight %, or from 70 weight % to 95 weight %, based on the total solids weight of the composition.

In some non-limiting embodiments, when secondary pigment component(s) are used, the cristobalite can comprise at least 5 weight %, or at least 10 weight % of the composition, based on total solids weight of the reflective granular composition. When secondary pigment component(s) are used, the cristobalite can also comprise up to 50 weight %, or up to 40 weight %, or up to 30 weight %, or up to 20 weight %, or up to 15 weight % of the composition, based on total solids weight of the reflective granular composition. In some non-limiting embodiments, when secondary pigment component(s) are used, the composition comprises an amount of cristobalite selected within a range of from 5 weight % to 20 weight, or from 10 weight % to 20 weight, based on total solids weight of the reflective granular composition.

As indicated above, the reflective granular compositions may also include, for example, kaolin clay. The type or source of the kaolin clay is not particularly limited. Non-limiting examples of kaolin clay materials include EPK kaolin (e.g., having an Fe content of about 0.93 wt %, where the reported Fe content is adjusted to exclude loss-on-ignition (LOI) and normalized to a total oxide content of 100%) available from Edgar Minerals (Edgar, FL), MCNAMEE kaolin (e.g., having an Fe content of about 0.38 wt %, where the reported Fe content is adjusted to exclude LOI and normalized to a total oxide content of 100%) available from Vanderbilt Minerals, LLC (Norwalk, CT), Kingsley kaolin (e.g., having an Fe content of 0.45 wt %, where the reported Fe content is adjusted to exclude LOI and normalized to a total oxide content of 100%) available from Kentucky-Tennessee Clay Company (Roswell, GA), 6 TILE kaolin (e.g., having an Fe content of about 0.4 wt %, where the reported Fe content is adjusted to exclude LOI and normalized to a total oxide content of 100%) available from Kentucky-Tennessee Clay Company (Roswell, GA), optiKasT kaolin (e.g., having an Fe content of about 0.58 wt %, where the reported Fe content is adjusted to exclude LOI and normalized to a total oxide content of 100%) available from Kentucky-Tennessee Clay Company (Roswell, GA), and lone Airfloated Kaolin (e.g., having an Fe content of about 0.7 wt %, where the reported Fe content is adjusted to exclude LOI and normalized to a total oxide content of 100%) available from lone Minerals, Inc. (lone, CA). The kaolin clay may comprise calcined kaolin clay.

The kaolin clay and other secondary pigments when used in the reflective granular composition may function as an additional highly solar reflective component, in addition to the cristobalite. The kaolin clay may be highly reflective at certain wavelengths of solar radiation which reach the Earth's surface. The kaolin clay may be reflective at the same or different wavelengths of solar radiation compared to the kaolin clay. Kaolin clay may be particularly effective at reflecting certain ultraviolet (UV) wavelengths of solar radiation. When the reflective granular composition is arranged at a surface of an object positioned in outdoor conditions, the kaolin clay may reflect at least a portion of the solar radiation incident to the object to reduce the rise in temperature of the object caused by the incident solar radiation (by the object absorbing less and reflecting more solar radiation compared to the same object coated with the same composition not containing kaolin clay).

In certain non-limiting embodiments, the reflective granular composition may comprise at least 50 weight %, or at least 55 weight % of the kaolin clay when used, based on total solids weight of the reflective granular composition. The reflective granular composition can also comprise up to 70 weight %, or up to 60 weight % of the kaolin clay when used, based on total solids weight of the reflective granular composition. In some non-limiting embodiments, when kaolin clay is used, the composition comprises an amount of kaolin clay selected within a range of from 50 weight % to 70 weight, or from 60 weight % to 70 weight, based on total solids weight of the reflective granular composition.

It will be appreciated that the reflective granular composition can comprise one or any combination of the previously described secondary pigment components, along with the cristobalite.

In certain non-limiting embodiments, the reflective pigment material is formed from only the cristobalite. That is, in certain non-limiting embodiments, 100 weight % of the reflective pigment material is solely made up of the cristobalite and is completely free of the secondary pigment components previously described.

The reflective granular composition may comprise an effective amount of the cristobalite, and optionally one or more secondary pigment components, so as to exhibit a bulk total solar reflectance (also referred to herein as “total solar reflectance” (TSR) or simply “solar reflectance”) of at least 70%, such as at least 80% or at least 85%, as measured using a reflectometer from Surface Optics Corporation (San Diego, CA). The reflective granular composition may exhibit a TSR of from 70-90%, from 80-90%, from 70-95%, or from 80-95%. For example, the 410-Solar visible/NIR Portable Reflectometer from Surface Optics Corporation (San Diego, CA) may be used, which measures reflectance over 7 wavelength bands and uses an algorithm to calculate the TSR.

The reflective granular composition may comprise an effective amount of the cristobalite, and optionally one or more secondary pigment components, so as to exhibit a UV reflectance (e.g., in the 335-380 nm wavelength band) of at least 20%, such as from 20% to 80%. In some non-limiting embodiments, the reflective granular composition may exhibit a UV reflectance of at least 25%, such as from 25% to 75%, from 25% to 70%, or from 40% to 70%, as measured using a solar reflectometer from Surface Optics Corporation (San Diego, CA). For example, in some non-limiting embodiments, the reflective granular composition may exhibit a UV reflectance of at least 50%, such as from 50% to 70%, as measured using a solar reflectometer from Surface Optics Corporation (San Diego, CA).

The reflective granular composition may comprise an effective amount of the cristobalite, and optionally one or more secondary pigment components, so as to exhibit a visible light (“VIS”) reflectance (e.g., in the 400-720 nm wavelength band) of at least 60%, for example from 60% to 97%, or from 60% to 95%, as measured using a solar reflectometer from Surface Optics Corporation (San Diego, CA). For example, in some non-limiting embodiments, the reflective granular composition may exhibit a VIS reflectance of at least 70%, for example, from 70% to 98%, or from 70% to 97%, as measured using a solar reflectometer from Surface Optics Corporation (San Diego, CA).

The reflective granular composition may comprise an effective amount of the cristobalite, and optionally one or more secondary pigment components, so as to exhibit an infrared light (“IR”) reflectance (e.g., in the 700-2500 nm wavelength band) of at least 60%, for example from 60% to 98%, or from 60% to 97%, as measured using a solar reflectometer from Surface Optics Corporation (San Diego, CA). For example, in some non-limiting embodiments, the particulate composition may exhibit an IR reflectance of at least 70%, for example, from 70% to 98% or from 70% to 97%, as measured using a solar reflectometer from Surface Optics Corporation (San Diego, CA).

As indicated, the reflective granular composition also includes a hardening agent. As used herein, “hardening agent” refers to an additive that improves the strength of the resulting reflective granular composition. The materials that form the hardening agent can also provide other benefits such as, for example, to help act as a binder. A “binder” refers to a constituent material that helps hold all compositional components together.

Non-limiting examples of hardening agents that can be used to form the reflective granular composition include sodium salts such as sodium silicate, sodium hydroxide, or a combination thereof. Further, non-limiting examples of suitable sodium silicates include potassium silicate, sodium potassium silicates, other metasilicates known in the art, or combinations thereof. Additional non-limiting examples of hardening agents include sodium carbonate, sodium chloride, sodium polyacrylate, sodium sulfate, sodium thiosulfate, sodium phosphate, or a mixture thereof.

In certain non-limiting embodiments, the hardening agent (e.g. sodium silicate) comprises at least 5 weight % of the composition, or at least 10 weight %, or at least 15 weight % of the composition, based on the total solids weight of the composition. The hardening agent (e.g. sodium silicate) can also comprise up to 40 weight % of the composition, or up to 30 weight %, or up to 25 weight %, or up to 20 weight % of the composition, based on the total solids weight of the composition. In some non-limiting embodiments, the composition comprises an amount of hardening agent selected within a range of from 5 weight % to 40 weight %, or from 5 weight % to 30 weight %, or from 5 weight % to 15 weight %, based on the total solids weight of the composition.

Moreover, in order to improve the consistency and adhesion of the particles within the slurry, materials that acts as a pure binder material may be added. Suitable binder materials include the class of water-soluble polymers, such as water-soluble synthetic polymers. Water-soluble synthetic polymers may contain hydrophilic functional groups, such as ethers, alcohols, amides, and pyrrolidones. In some non-limiting embodiments or aspects, the binder material may comprise polyvinyl alcohol.

In certain non-limiting embodiments, the method of preparing the reflective granular composition includes: mixing together quartz sand with water to form a slurry; adding and mixing a hardening agent into the slurry; granulating and/or drying the slurry; kilning a resulting material to form a sintered material comprising cristobalite and the hardening agent; and crushing and sieving the sintered material to form a reflective granular composition having a desired particle size. It will be appreciated that the granulated and/or dried slurry is kilned such that the quartz sand is converted into cristobalite. It is appreciated that the quartz sand can include course sand, fine sand, whole sand, ground sand, or any combination thereof.

As previously described, quartz sand is mixed with water and a hardening agent to form a slurry. The slurry may form a substantially homogeneous mixture. As used herein, the term “substantially” is used as a term of approximation, and not as term of degree, and is intended to account for the inherent deviations and variations in measured, observed or calculated properties or values. Accordingly, the term “substantially homogeneous” denotes that the while the mixture may not be perfectly homogeneous, the mixture would be considered homogeneous by those of ordinary skill in the in the art.

In some non-limiting embodiments, a method of forming the slurry may include adding a liquid media (e.g., water) to the mixture of components until a desired consistency is achieved. The desired consistency at this stage of the process may vary depending on a variety of factors, e.g., whether the composition is desired to be ultimately moldable or flowable. In some non-limiting embodiments, however, the liquid media may be added to the particulate mixture in an amount of from 20 to 50% by weight, such as from 30 to 40% by weight, based on the total weight of the slurry mass. For example, in some non-limiting embodiments in which the composition is desired to be moldable, the liquid media may be added to the particulate mixture in an amount of from 20 to 40% by weight, such as from 25 to 35% by weight or from 25 to 30% by weight, based on the total weight of the slurry mass. In some non-limiting embodiments in which the composition is desired to be flowable, the liquid media may be added to the particulate mixture in an amount of from 30 to 50% by weight, such as from 35 to 45% by weight or 35 to 40% by weight, based on the total weight of the slurry mass.

The slurry may then be processed into granule form. In some non-limiting embodiments, a method may further include extruding the slurry, or spray granulating the slurry, and/or then optionally drying the extruded or sprayed product. The drying may be performed at any suitable temperature to substantially drive off the liquid media. As discussed above, as used herein, the term “substantially” is a term of approximation, and not a term of degree, and the phrase “substantially drive off the liquid media” is intended to account for inherent deviations in the measurement, calculation or observation of the amount of the liquid media remaining in the mixture after drying. For example, the liquid media would be considered substantially driven off if the amount of liquid media remaining in the mixture is either not detectable or is otherwise negligible, as would be understood by those of ordinary skill in the art.

The temperature for drying the slurry is not particularly limited, and it may vary depending on the liquid media selected. However, the temperature should be high enough to substantially drive off the liquid media, but not high enough to constitute a heat treatment or kilning procedure. For example, drying may be performed at a temperature of from 100 °C to 800 °C, such as from 100 °C to 700 °C, from 120 °C to 160 °C, from 130 °C to 150 °C, or from 100 °C to 130 °C. Additionally, the time needed to dry the wet mixture is not particularly limited, and it may vary depending on the consistency of the wet mixture, the liquid media used in the wet mixture, the temperature used to perform the drying, and the amount of the liquid media in the wet mixture. In some non-limiting embodiments, drying is performed for from 10 minutes to 90 minutes, such as from 20 minutes to 70 minutes, or from 30 minutes to 60 minutes.

The dried mixture may be crushed and/or kilned (or subjected to heat treatment). In embodiments in which the dried mixture is both crushed and kilned, the dried mixture may either be crushed first and then kilned, or kilned first, and then crushed. In some non-limiting embodiments, the dried mixture may first be crushed (prior to kilning) to the desired particle size, using a crusher and sieves of the desired size. This pre-crushing may allow any fine materials (or fine particulates) to be re-introduced into the product feed, thereby reducing the amount of waste material generated by the process. The fine particles generated during the crushing process may be recycled by reintroducing them into the production feed. However, because of their smaller particle size, the amount of the liquid media needed to reach the desired consistency of the wet mixture may be increased. In some non-limiting embodiments, the recycled fine particles may be added to the production feed in amount of from 25 wt % of the feed or less.

As discussed above, according to some non-limiting embodiments, the dried mixture may be kilned either before or after crushing. The kilning process may be performed at any suitable temperature and for any suitable length of time. For example, in some non-limiting embodiments, the dried mixture (either before or after crushing) may be kilned (or fired) at a temperature of from 800 °C or 900 °C to 1500 °C, such as from 1000 °C to 1300 °C, or from 1025 °C to 1275 °C, or from 1050 °C to 1250 °C. Additionally, in some non-limiting embodiments, the dried mixture may be kilned (or fired) for from 30 minutes to 90 minutes, such as from 45 minutes to 75 minutes, from 50 minutes to 70 minutes, or for 60 minutes. As previously described, the kilning process is conducted in order to bond the quartz sand particles together and convert the quartz sand into cristobalite.

The resulting granules, in some non-limiting embodiments, may have a bulk density of from 40 lbs/ft³ to 75 lbs/ft³, such as from 50 lbs/ft³ to 75 lbs/ft³, from 40 lbs/ft³ to 60 lbs/ft³, from 50 lbs/ft³ to 60 lbs/ft³, or from 45 lbs/ft³ to 60 lbs/ft³. In some non-limiting embodiments, the resulting granules particulate composition may have a bulk density of from 50 lbs/ft³ to 60 lbs/ft³, such as from 52 lbs/ft³ to 58 lbs/ft³, or from 53 lbs/ft³ to 56 lbs/ft³. The relatively low bulk density of the particulate composition enables significant cost savings. For example, the lower bulk density allows the application of fewer of the particulates (or granules) per unit area (or square) while still achieving the solar reflectance benefits (such as, for example, high total solar reflectance, and/or UV, VIS and/or IR reflectance).

A compound, such as a clear treatment or clear coating compound may be applied to the reflective granular composition to coat or treat the surface of the granules. Such compounds include, but are not limited to at least one of the following: silanes, siloxanes, polysiloxanes, organo-siloxanes, silicates, organic silicates, silicone resins, acrylics, urethanes, polyurethanes, glycol ethers and mineral oil. Exemplary coatings, surface treatments, and methods of coating and treating particles are shown and described in U.S. Pat. Nos. 7,241,500, 3,479,201, 3,255,031, 3,208,571, and US 2020/0308413, all of which are incorporated herein by reference in their entireties. The coating applied to the granules may provide enhanced protection of the granules against staining from asphalt.

To maintain the high solar reflectance of the granules, the compound should be applied thereto such that the coating and/or surface treatment does not significantly decrease the reflectance of the granules. For example, many suitable coatings and/or surface treatments may be sealants or otherwise clear coatings that do not adversely affect the overall solar reflectance of the granules. In some non-limiting embodiment, the granules may be treated with an emulsion of silanes and siloxanes without added solvents. In another embodiment, the granules may be treated with SILRES BS3003, available from Wacker Chemi AG (Munich, Germany).

The surface treatments and/or coatings can be applied to the granules using a variety of methods and processes known to those of skill in the art. For example, in one exemplary embodiment, after the raw material has been crushed and sized according to the preferred screen size and packaged, the particles can be treated by adding the particles to an aqueous solution fully saturating the particles with the treatment and then, immediately drying the particles to drive off excess moisture at a temperature not exceeding 600 °F (316 °C). In another exemplary embodiment, after the raw material has been crushed and sized according to the preferred screen size and packaged, the particles can be post-treated by spraying the particles with an aqueous solution and then immediately drying the particles to drive off excess moisture at a temperature not to exceed 600 °F (316 °C). In yet another exemplary embodiment, after the raw material has been crushed and sized according to the preferred screen size, the particles can be treated by spraying the particles with an aqueous solution and then immediately kiln drying the particles to drive off excess moisture at a temperature not to exceed 600 °F (316 °C) after which time they can be packaged. In still yet another embodiment of coating and/or treating the surface of granules, after the raw material has been crushed and sized according to the preferred screen size, the particles are treated by spraying with an aqueous solution followed by immediately aerating the particles to drive off excess moisture after which time the particles can be packaged. The coatings and/or surface treatments may be applied as delivered (e.g., off the shelf) or from aqueous dilutions. The dilution ratio may range from 1:5 to 1:200. The dilutions may be prepared from demineralized water.

In certain non-limiting embodiments, the reflective granules are crushed and sized to have a particle size selected within a range of from 8 mesh to 40 mesh.

In certain non-limiting embodiments, the method of preparing a reflective granular composition comprises: mixing together cristobalite, and a hardening agent (as previously described) to form a reflective granular composition. The method can further comprise crushing and sieving the reflective granular composition to have a desired particle size, such as a particle size selected within a range of from 8 mesh to 40 mesh.

The reflective granular composition (e.g., untreated or treated) may be used to form an architectural material. The architectural material may comprise a roofing material or other building material. The architectural material may be positioned in an outdoor environment.

The roofing material may be formed by applying the reflective granular composition to an asphalt layer. The asphalt layer may comprise bitumen or modified bitumen, modified with at least one reinforcing material, such as polyester or fiberglass. Such roofing material having the reflective granular composition applied to an asphalt layer may constitute a cool roof system.

### EXAMPLES

The following examples are presented to demonstrate the general principles of the disclosure. The disclosure should not be considered as limited to the specific examples presented. All parts and percentages in the examples are by weight unless otherwise indicated.

### Example 1

### Preparation of a Reflective Granular Composition

A reflective granular composition was prepared by first mixing 600 g of dry quartz sand (Min-U-Sil® 10, commercially available from U.S. Silica) with D90 of 10 μm was mixed in water. Next, 60 g of a 50% concentration of sodium silicate solution (N®, commercially available from PQ Corporation) was added to the mixture and the final concentration of sand was adjusted to 50% by adding water to form the final slurry. The slurry was dried overnight at 100 °C and the dried mass was then kilned in a furnace at 1150 °C for 2 hours to be sintered before being allowed to cool to ambient temperature. The sintered material was crushed through a jaw crusher and sieved to form granules so that the particle sizes were within 8 mesh and 40 mesh.

The granules were measured for TSR using Devices and Services Solar Spectrum Reflectometer Model SSR. The resulting TSR of the granules was 95.133.

### Examples 2-6

### Preparation of Reflective Granular Compositions

Reflective granular compositions were prepared with the same materials and steps as Example 1 but with varying amounts of sodium silicate as shown in Table 1. Each of the reflective granular compositions of Examples 2-6 exhibited an excellent TSR.

TABLE 1

| Examples | Formulation | TSR |
|---|---|---|
| 2 | Minusil-10 + 5% N ® Sodium Silicate | 95.12 |
| 3 | Minusil-10 + 15% N ® Sodium Silicate | 93.33 |
| 4 | Minusil-10 + 20% N ® Sodium Silicate | 92.60 |
| 5 | Minusil-10 + 25% N ® Sodium Silicate | 92.13 |
| 6 | Minusil-10 + 30% N ® Sodium Silicate | 89.93 |

### Example 7

### Preparation of a Reflective Granular Composition

A reflective granular composition was prepared by first mixing 600 g of dry quartz sand (Min-U-Sil® 5, commercially available from U.S. Silica) with D90 of 5 μm was mixed in water. Next, 360 g of a 50% concentration of sodium silicate solution (N®, commercially available from PQ Corporation) was added to the mixture and the final concentration of sand was adjusted to 50% by adding water to form the final slurry. The slurry was dried overnight at 100 °C and the dried mass was then kilned in a furnace at 1150 °C for 2 hours to be sintered before being allowed to cool to ambient temperature. The sintered material was crushed through a jaw crusher and sieved to form granules so that the particle sizes were within 8 mesh and 40 mesh.

The granules were measured for TSR using Devices and Services Solar Spectrum Reflectometer Model SSR. The resulting TSR of the granules was 91.17.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

1. A reflective granular composition comprising:
a reflective pigment material comprising cristobalite; and
at least 5 weight % of a hardening agent, based on the total solids weight of the composition.

2. The reflective granular composition of claim 1, wherein the hardening agent comprises a sodium salt.

3. The reflective granular composition of claim 1, wherein the reflective pigment material consists of cristobalite.

4. The reflective granular composition of claim 3, wherein the composition comprises at least 50 weight % cristobalite, based on the total solids weight of the composition.

5. The reflective granular composition of claim 4, wherein the composition comprises an amount of cristobalite selected with a range of from 50 weight % to 95 weight %, based on the total solids weight of the composition.

6. The reflective granular composition of claim 1, wherein the composition comprises an amount of hardening agent selected with a range of from 5 weight % to 40 weight %, based on the total solids weight of the composition.

7. The reflective granular composition of claim 1, wherein the cristobalite has a d90 selected with a range of from 1 μm to 40 μm.

8. The reflective granular composition of claim 1, wherein the reflective granules have a particle size selected within a range of from 8 mesh to 40 mesh.

9. The reflective granular composition of claim 1, wherein the reflective pigment material further comprises a secondary pigment component selected from the group consisting of: kaolin clay, metal and transition metal oxides, alkaline earth metal sulfates, alkaline earth metal carbonates, transition metal silicates, minerals, and mixtures thereof.

10. The reflective granular composition of claim 1, wherein the composition exhibits a total solar reflectance of at least 70%.

11. An architectural material comprising the reflective granular composition of claim 1.

12. The architectural material of claim 11, wherein the architectural material comprises a roofing material.

13. A method of preparing a reflective granular composition comprising:
mixing together quartz sand with water to form a slurry;
adding and mixing a hardening agent into the slurry;
granulating and/or drying the slurry;
kilning a resulting material to form a sintered material comprising cristobalite and the hardening agent.

14. The method of claim 13, wherein the kilning is performed at a temperature of from 900 °C to 1500 °C.

15. The method of claim 13, wherein the sintered material is crushed and sieved to form the reflective granular composition having a desired particle size.

16. The method of claim 13, wherein the hardening agent comprises a sodium salt.

17. The method of claim 13, wherein a reflective pigment material of the reflective granular composition consists of cristobalite.

18. The method of claim 13, wherein the reflective pigment material further comprises a secondary pigment component selected from the group consisting of: kaolin clay, metal and transition metal oxides, alkaline earth metal sulfates, alkaline earth metal carbonates, transition metal silicates, minerals, and mixtures thereof.

19. A method of preparing a reflective granular composition comprising:
mixing together cristobalite, and a hardening agent to form a reflective granular composition.

20-21. (canceled)

22. The method of claim 15, wherein the sintered material is crushed and sieved to form the reflective granular composition having a particle size selected within a range of from 8 mesh to 40 mesh.
